(19) United States
(12) Patent Application Publication
(10) Pub. No.: US 2008/0143203 A1
(43) Pub. Date: Jun. 19, 2008

(54) Over molded stator

(76) Inventors: Stephen H. Purvines, Mishawaka, IN (US); Gary F. Glass, Wabash, IN (US)

Correspondence Address: BROOKS, CAMERON & HUEBSCH , PLLC, 1221 NICOLLET AVENUE , SUITE 500, MINNEAPOLIS, MN, 55403, US

(21) Appl. No.: 12/072,057

(22) Filed: Feb. 22, 2008

Related U.S. Application Data
(62) Division of application No. 11/106,852, filed on Apr. 15, 2005.

(51) Int. Cl. H02K 5/22

(52) U.S. Cl. 310/71; 310/89

(57) ABSTRACT

Devices and methods are provided for an improved motor stator. One embodiment for a stator includes a stator section having a first surface and a second surface each surface having a groove extending into the stator section and a slot extending longitudinally between the first and second surfaces. Insulated conductive wires are wound longitudinally around the stator section in the slots to form winding turns contained completely within each groove. A lead frame extends circumferentially along a surface of the stator and the insulated conductive wires couple to the lead frame. A thermoset material is supplied to the stator section to encapsulate the stator section including the lead frame and the insulated conductive wires, and to provide integral coolant flow passages.

### PRIORITY INFORMATION

This application is a Divisional of U.S. patent application Ser. No. 11/106,852 filed Apr. 15, 2005, the specification of which is incorporated by reference herein.

### INTRODUCTION

Electrical induction motors include a stator and a rotor to convert electrical energy into a magnetic interacts that create motion. The stator can include a number of stator sections configured to form in a ring-like cylinder. The ring-like cylinder of the stator receives the rotor in such a way as to allow the two structures to magnetically interact to create motion.

One aspect of creating this magnetic interaction is found in the stator sections. Each stator section includes slots that receive windings of conductive wire that form stator coils. When a potential is applied through the stator coils an electromagnetic field can be generated. In addition to the electromagnetic field, heat can also be generated due to the electrical resistance of the conductive wire. The more efficiently this heat can be dissipated, the more efficiently the motor can run.

### BRIEF DESCRIPTION OF THE DRAWINGS

FIG. 1A illustrates one embodiment of an electric motor stator and rotor according to the present invention.

FIG. 1B illustrates a transverse cross-sectional view of the electric motor illustrated in FIG. 1A taken along lines IB-IB.

FIG. 2 illustrates a cross-sectional view of an electric motor according to one embodiment of the present invention.

FIGS. 3A-3C illustrate various embodiments of a stator section according to the present invention.

FIGS. 4A-4C illustrate various embodiments of a stator section according to the present invention.

FIG. 5 illustrates an embodiment of a lead frame coil termination plate prior to singulation according to the present invention.

FIG. 6 illustrates one embodiment of a stator and a lead frame according to the present invention.

FIGS. 7A-7B illustrates one embodiment of a molding tool for over molding a stator according to the present invention.

FIG. 8A illustrates one embodiment of a stator housing for an over molded stator.

FIG. 8B illustrates one embodiment of a stator encapsulated within a thermoset material and secured within a stator housing.

### DETAILED DESCRIPTION

Embodiments of the present disclosure include electric motors, components of electric motors, and methods associated therewith for improved electric motor operation and manufacturing methods. It will be apparent to those skilled in the art that the following description of the various embodiments of this disclosure are provided for illustration only and not for the purpose of limiting the invention as defined by the appended claims and their equivalents.

As will be described herein, an electric motor includes, among other things, a housing, a rotor, and a stator disposed around the rotor and fixed within the housing. In the embodiments described in the present disclosure, the stator is completely encapsulated within a thermoset material. In some embodiments, electrical connectors, which form an electrical connection between the stator and a power supply, extend from the completely encapsulated stator. As used herein, a thermoset material includes those polymeric materials that once shaped by heat and pressure so as to form a cross-linked polymeric matrix are incapable of being reprocessed by further application of heat and pressure.

As discussed herein, the stator is formed of a number of annularly arranged stator sections. Each stator section can include slots and grooves in which insulated conductive wire is wound. In one embodiment, grooves in the stator sections allow the conductive wire to be wound on the stator sections without extending above an upper and/or lower surface of the stator section. In other words, turns in the windings are contained completely within the annularly arranged stator section groove.

In additional embodiments, the stator further includes a lead frame that extends circumferentially along a surface of the stator for coupling the insulated conductive wires to the lead frame. In various embodiments, the stator sections, the insulated conductive wires, and the lead frame are then completely encapsulated within the thermoset material such that only the electrical connectors extend from the thermoset material.

In additional embodiments, the stator can also include a stator housing having inwardly facing protrusions arranged axially around an inner surface of the stator housing. As will be discussed, the inwardly facing protrusions can serve as a register for stator sections, as a register for a molding tool, and/or as a register for an electric motor housing. Some embodiments of the stator housing can also include a number of coupling members for securing a end cap to the stator housing to thereby enclose the stator housing.

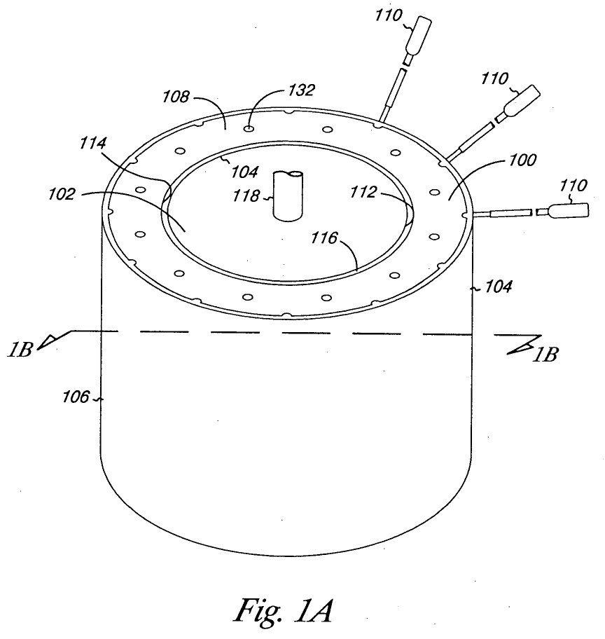

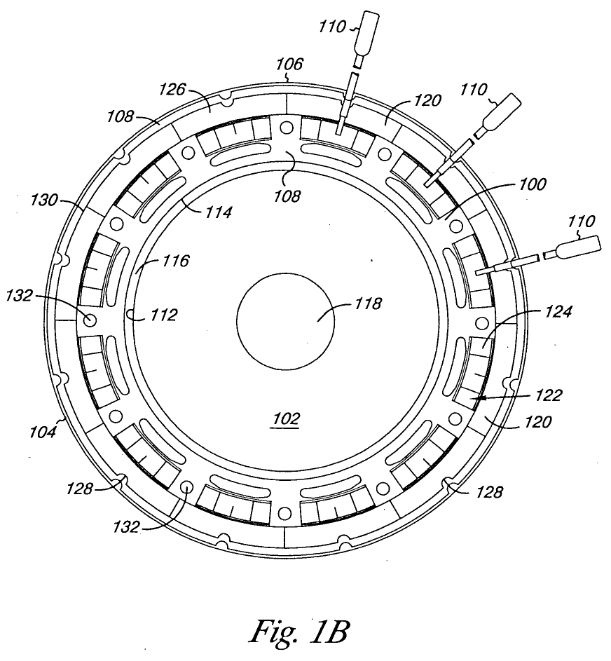

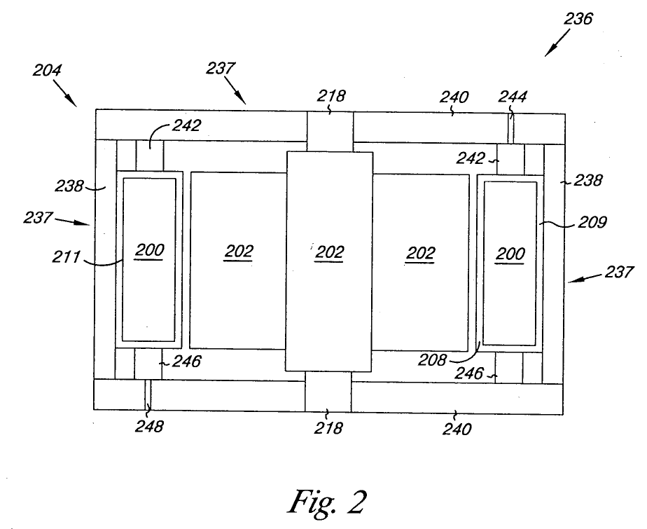

The Figures herein follow a numbering convention in which the first digit or digits correspond to the drawing figure number and the remaining digits identify an element in the drawing. Similar elements between different figures may be identified by the use of similar digits. For example, 102 may reference element “102” in FIG. 1A, and a similar element may be referenced as “202” in FIG. 2A. As will be appreciated, elements shown in the various embodiments herein can be added, exchanged, and/or eliminated so as to provide a number of additional embodiments.

In describing the various embodiments herein, the following directional terms “annular,” “axial,” “circumferential,” “radial,” “longitudinal” and “transverse” as well as other similar directional terms may be used. As used herein, these directional terms as well as other directional terms refer to those directions of the electric motor relative to a center rotational axis of a rotor of the electric motor. Accordingly, these terms, as used to describe the embodiments described herein should be interpreted relative to the center rotational axis of the rotor of the electric motor.

The Figures presented herein provide illustrations of non-limiting example embodiments of the present invention. For example, FIGS. 1A and 1B illustrate different views of one embodiment of a stator 100 and a rotor 102 for use in an electrical motor according to the present invention. FIG. 1A provides a perspective view of the stator 100 and the rotor 102, while FIG. 1B provides a transverse cross-sectional view of the stator 100 and the rotor 102 of the electric motor.

As will be appreciated, embodiments of the stator 100 and the rotor 102 of the present invention can be utilized in a variety of motor configurations. For example, suitable motor configurations can include motors that operate on alternating current (AC) (i.e., induction or synchronous AC motor, switched reluctance motor) and/or direct current (DC) (e.g., a universal motor or a DC motor). As understood, AC motors can be configured as a single-phase, split-phase, poly-phase, or a three-phase motor. Furthermore, it will be apparent to those skilled in the art from this disclosure that although the present invention is used with an electric motor, the present invention can be used with other rotary type electric machines such as a generator or motor/generator.

The stator 100 and rotor 102 of the electric motor illustrated in FIG. 1A includes a stator housing 104. As illustrated, the stator housing 104 encases at least a portion of the stator 100. In addition, FIG. 1A illustrates the stator 100 completely encased by a thermoset material 108. As illustrated, the stator 100 can be completely encased by the thermoset material 108, but having electrical connectors 110 extending from the thermoset material.

As used herein, a thermoset material includes those polymeric materials that once shaped by heat and pressure so as to form a cross-linked polymeric matrix are incapable of being reprocessed by further application of heat and pressure. As provided herein, thermoset materials can be formed from the polymerization and cross-linking of a thermoset precursor. Such thermoset precursors can include one or more liquid resin thermoset precursors. In one embodiment, liquid resin thermoset precursors include those resins in an A-stage of cure. Characteristics of resins in an A-stage of cure include those having a viscosity of 1,000 to 500,000 centipoises measured at 77° F. (Handbook of Plastics and Elastomers, Editor Charles A. Harper, 1975).

In the embodiments described herein, the liquid resin thermoset precursor can be selected from an unsaturated polyester, a polyurethane, an epoxy, an epoxy vinyl ester, a phenolic, a silicone, an alkyd, an allylic, a vinyl ester, a furan, a polyimide, a cyanate ester, a bismaleimide, a polybutadiene, and a polyetheramide. As will be appreciated, the thermoset precursor can be formed into the thermoset material by a polymerization reaction initiated by heat, pressure, catalysts, and/or ultraviolet light.

As will be appreciated, the thermoset material used in the embodiments of the present invention can include non-electrically conducting reinforcement materials and/or additives such as non-electrically conductive fillers, fibers, curing agents, inhibitors, catalysts, and toughening agents (e.g., elastomers), among others, to achieve a desirable combination of physical, mechanical, and/or thermal properties.

Non-electrically conductive reinforcement materials can include woven and/or nonwoven fibrous materials, particulate materials, and high strength dielectric materials. Examples of non-electrically conductive reinforcement materials can include, but are not limited to, glass fibers, including glass fiber variants, synthetic fibers, natural fibers, and ceramic fibers.

Non-electrically conductive fillers include materials added to the matrix of the thermoset material to alter its physical, mechanical, thermal, or electrical properties. Such fillers can include, but are not limited to, non-electrically conductive organic and inorganic materials, clays, silicates, mica, talcs, asbestos, rubbers, fines, and paper, among others.

In an additional embodiment, the liquid resin thermoset precursor can include a polymerizable material sold under the trade designator “Luxolene” from the Kurz-Kasch Company of Dayton Ohio.

FIG. 1B illustrates a transverse cross-sectional view of the stator 100 and the rotor 102 illustrated in FIG. 1A. As shown in FIG. 1B, the stator 100 is secured in cylindrical plate 106 of the stator housing 104 and circumferentially surrounds the rotor 102.

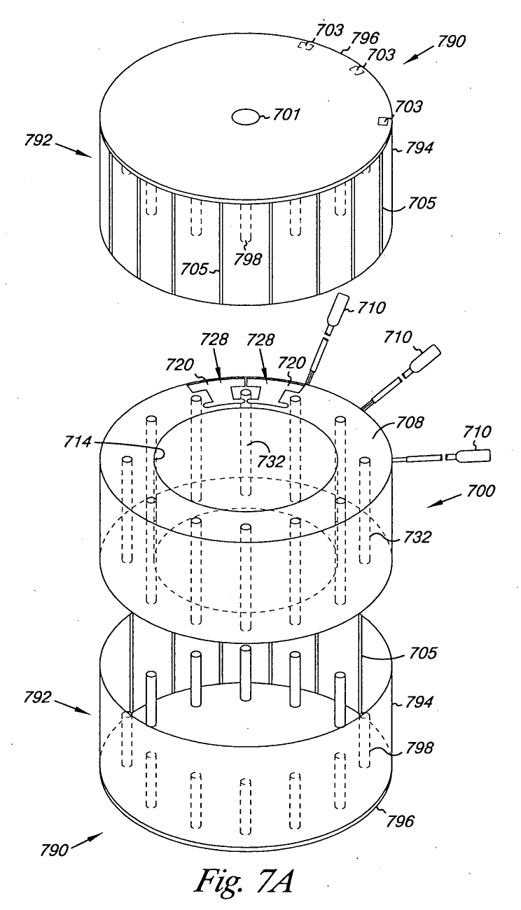

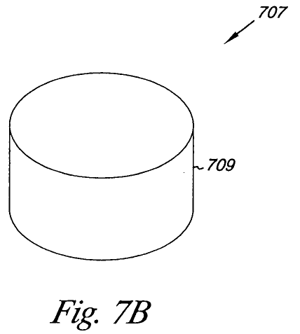

The rotor 102 is positioned inside the stator 100 in such a way that when the rotor 102 rotates, an outer surface 112 of the rotor 102 is proximate to, but does not touch, an inner surface 114 of the stator 100. In various embodiments, a space defined by the outer surface 112 of the rotor 102 and the inner surface 114 of the stator 100 is an air gap 116. As will be discussed below with respect to FIGS. 7A and 7B, the inner surface 114 of the stator 100 formed of the thermoset material 108 can be used to dictate the size of the air gap 116 required to conform to the type of electric motor in which the stator is used including the electrical, mechanical, and electromagnetic considerations (i.e., flux) for each type of electric motor.

As will be appreciated, the rotor 102 is housed at least partially within and rotates relative the stator 100 about a rotational shaft 118 supported by structures that include bearings (not shown). The stator 100 includes a number of annularly arranged stator sections 120. The stator sections 120 each include slots 122 that extend longitudinally along the length of the stator section 120. In addition, the stator sections 120 can further include grooves (not shown, but illustrated herein) that extend between the slots 122. The slots 120 and grooves receive a number of stator coils 124 formed of insulated conductive wire wound within the slots 122 and the grooves.

As illustrated, the stator 100 of FIG. 1B includes twelve (12) stator sections 120 arranged annularly such that the outer portions 126 of each stator section 120 are in physical contact with the adjacent stator section 120 to form a contiguous cylindrical structure of the stator 100. As will be appreciated, stators formed according to the teachings of the present invention can include various numbers of stator sections 120 and thus, the embodiment illustrated in FIG. 1B is not meant to limit the present invention but rather to show one of many stators that can be formed with the stator section 120. For example, in some embodiments, the stator 100 can include four (4) annularly arranged stator sections 120 to form the stator 100. As will be appreciated, in such an embodiment, each stator section 120 will be larger such that when they are annularly arranged, they form a contiguous cylindrical stator.

In an additional embodiment, the stator section 120 can include at least one recess 128 positioned on an outer surface 130 of the stator section 120. Like the inner surface 114 of the stator 100, which is formed of a thermoset material 108, in some embodiments, the outer surface 130 of the stator 130 can be formed of the thermoset material 108 during the over molding process, discussed herein.

The stator 100 can further include one or more channels 132 extending longitudinally through the stator 100. In one embodiment, the thermoset material 108 over molding the stator 100 includes surfaces that define the one or more channels 132. The channels 132 provide fluid paths for the circulation of cooling fluid through the stator 100, as will be discussed further herein. As illustrated, each of the channels 132 is positioned proximal to and between adjacent stator sections 120. The channels 132 are part of a heat exchange system (illustrated in FIG. 2 below) that provide for the circulation of a cooling fluid for helping to cool the stator 100.

In the embodiment shown in FIG. 1B, the channels 132 are positioned between stator sections 120 and adjacent the insulated conductive wires that form the stator coils 124 of each stator section 120. Providing the channels 132 in this position relative the stator coils 114 is believed to provide for better cooling efficiency for the stator 100. In addition, the thermoset material 108 defining the channels 132 can be formulated to be highly resistant to the abrasive characteristics found in cooling fluids.

The stator 100 also includes electrical connectors, shown as 110 in FIG. 1A. The electrical connectors 110 can be coupled to additional electrical components of the motor in which the stator 100 is being used (e.g., a power source). In various embodiments, the electrical connectors 110 can extend from the stator 100 in a number of directions and in a number of ways.

In some embodiments, such as the embodiment illustrated in FIG. 1A, the electrical connectors 110 extend away from the rotor 102 and perpendicularly relative to the outer surface 130 of the stator 100. In one embodiment, the electrical connectors 110 can extend through the cylindrical plate 106 of the stator housing 104. In other embodiments, the electrical connectors 110 can extend longitudinally relative to a rotational axis of the rotor 102. In such embodiments, the electrical connectors 110 can couple to the additional electrical components of the motor in which the stator 100 is being used without extending the electrical connectors 110 through the cylindrical plate 106 of the stator housing, but rather, through end caps (shown as 240 in FIG. 2). Other connection configurations are also possible.

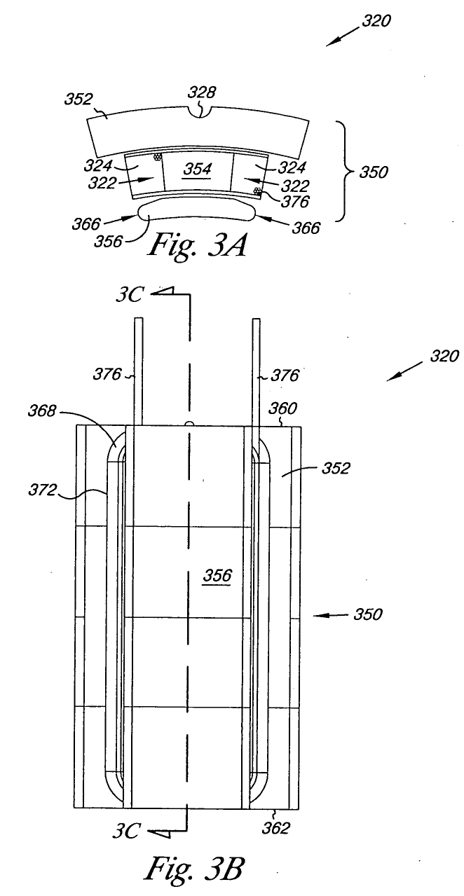

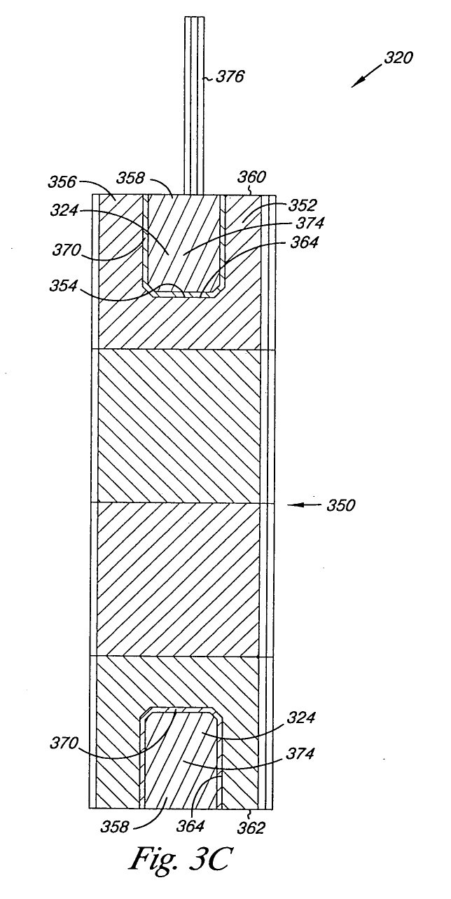

In the embodiments described herein, the electrical connectors 110 are coupled to a lead frame, which in turn, is coupled to terminal portions of insulated conductive wires that form the stator coils 124. As discussed herein, the lead frame extends circumferentially around the stator 100 and above each stator segment 120. The electrical connectors 110 are coupled to the lead frame such that the electrical connectors 110, the lead frame, and the terminal portions of the stator coils 124 form an electrical conduit for conducting electrical potential between the stator 100 and a power source. As illustrated with respect to FIGS. 3A-3C, the configuration of the lead frame, and the terminal portions of each stator coil 124 can provide various stator embodiments with features that include reducing the size of the stator and providing an efficient way to connect terminal portions of each stator core to the lead frame, as discussed herein.

FIG. 2 provides a cross-sectional illustration of an electrical motor 236 that includes the stator 200 encapsulated with the thermoset material 208 according to one embodiment of the present invention. As shown in FIG. 2, the motor housing 237 of the electric motor 236 includes a cylindrical plate 238 and end caps 240 located at first and second axially facing ends of the cylindrical plate 238. Also illustrated in FIG. 2 is the rotor 202 having its rotational shaft 218 passing at least partially through the motor housing 237.

FIG. 2 further illustrates portions of a heat exchange system for cooling the stator 200 and the motor 236. In general, the heat exchange system circulates cooling fluid through the channels 132, as seen in FIGS. 1A and 1B, to cool the stator coils and other portions of the stator 200. For example, in one embodiment, cooling fluid can be pumped into inlet chamber 242 through inlet port 244 defined at least partially by the end cap 240 of motor housing 237. The inlet chamber 242 can be fluidly coupled to the channels, where the cooling fluid moves through the inlet chamber 242 into the channels of the stator 200. The cooling fluid then passes from the channels into an outlet chamber 246. The output chamber 246 connects to an outlet port 248 defined at least partially by the end cap 240 of the motor housing 237. As will be appreciated, the outlet port 248 and the inlet port 244 can be used in a closed loop heat exchange system in which cooling fluid is circulated through at least the stator 200 to absorb heat and through a radiator structure to transfer heat from the cooling fluid.

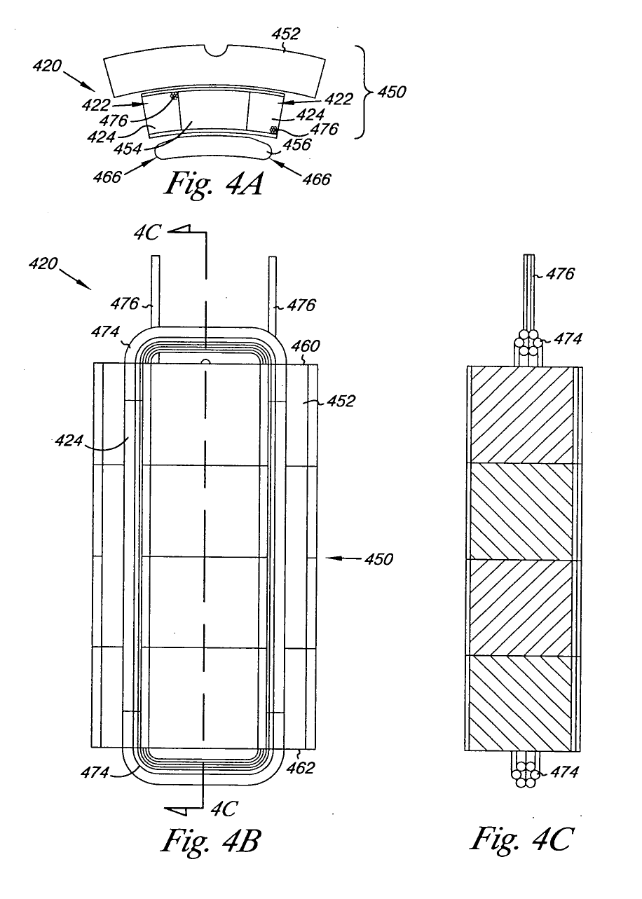

As discussed herein, a number of annularly arranged stator sections can be joined to form a contiguous cylindrical stator. FIGS. 3A-3C and 4A-4C illustrate two embodiments of a stator section according to the present invention. The embodiments illustrated in FIGS. 3A-3C and 4A-4C are not intended to limit the various stators that can be formed according to the teachings of the present invention, but rather, to provide an understanding of the various stator sections that can be used to form various types of stators. In addition, some details of the stator section illustrated in FIGS. 3A-3C and 4A-4C have been simplified (e.g., stacked metal laminations not illustrated) so as to allow better illustration of the embodiments of the present invention.

FIG. 3A illustrates a top down view of the stator section 320. FIG. 3B illustrates a side view of the stator section 320. FIG. 3C illustrates a cross-sectional view of the stator section 320 taken along cut line 3C-3C.

In the embodiments illustrated in FIGS. 3A-3C, the stator section 320 includes a stator core 350 formed, for example, of stacked metal laminations, as will be discussed below. The stator core 350 has an outer portion 352, a middle portion 354, and an inner portion 356. The inner portion 356 extends inwardly from the middle and outer portions 354 and 352 in a radial direction. The inner portion 356 of each stator section 320 serves as a magnetic pole for a stator, as discussed herein. The middle portion 354 of the stator section 320 further includes surfaces that help to define the slots 322 and grooves 358 in which the stator coil 324 is wound. The outer portion 352 includes the recess 328 that can be used to both register the stator section 320 within the stator housing and/or a molding tool, and provides a surface with which to positively engage the stator with the stator housing, as will be discussed below with respect to FIGS. 7A-7B.

As shown in FIGS. 3A-3C, the stator core 350 can be formed of four blocks of stacked laminations of metal. The stator core 350 can include various types of stacks of metal laminations. For example, in some embodiments, the stacked laminations forming the stator sections can be of iron and/or other metal or metal alloys that can provide a magnetic field (e.g., cobalt, nickel, alloys thereof). As will be appreciated, the stator core 350 can be formed of varying numbers of blocks of stacked laminations of metal (e.g., one block or more).

The stator core 350 further includes a first end 360 and a second end 362 having surfaces 364 that define the groove 358 that extends a predetermined distance into the middle portion 354 of the stator core 350. As shown in FIG. 3C, the distance that each groove 358 extends into the middle portion 354 of the stator core 350 is equal. In some embodiments, the predetermined distance that the grooves 358 extend into the stator core 350 can vary relative another groove 358 in the same or different stator core 350. For example, in some embodiments, the groove 358 at the first end 360 of the stator section 320 can include a larger predetermined distance than the groove 358 at the second end 362.

The stator section 320 also includes slots 322 extending longitudinally along the middle portion 354 of the stator core 350 between the first and second ends 360 and 362 of the stator section 320. The slots 322 include a predetermined depth relative to edges 366 of the inner portion 356 of the stator section 320. As the reader will appreciate, the depth of the slots 322 correspond to the width of the inner portion 356 of the stator section relative the outer portion 352 of the stator section 320. Thus, the dimensions of the various portions of the stator section 320 can be designed to accommodate varying diameters and lengths of insulated conductive wires 368 that form the stator coils 324. For example, in various embodiments, the grooves 358 and the slots 322 defined at least in part by the middle portion 354 of the stator core 350 can accommodate a number of insulated conductive wires 368 wound around the stator slots 322 and within the grooves 358 to form stator coils 324.

The stator section 320 can further include an insulator 370 positioned between the stator coils 324 and the surface of the stator core 350. For example, the insulator 370 can include a layer of insulating material disposed on the surfaces defining the grooves 358 and the slots 322 of the stator section 320. Examples of suitable insulating material can include, but are not limited to, NOMEX, MYLAR, TufQUIN, and the like. In some embodiments, the insulator 370 can be disposed along surfaces of the stator section 320 and between portions of the stator sections 320. For example, the insulator 370 can be positioned between each lamination in a stack of laminations of a stator section 320 and along surfaces of the stacked laminations. In the embodiment shown in FIG. 3C, for example, the insulator 370 lines the grooves 358 to further aid in electrically isolating the insulated conductive wires 368 from the stator core 350.

As discussed herein, the stator section 320 includes stator coils 324 formed from a number of insulated conductive wires 368 (e.g., copper wire). In various embodiments, the insulated conductive wire 368 can include various cross-sectional shapes. For example, in some embodiments, the insulated conductive wires 368 can include a round cross-sectional shape, and in other embodiments, the insulated conductive wire 368 can include a planar or rectangular cross-sectional shape (i.e., flat). The insulated conductive wire 368 can also include a wire insulator 372 such as a resin layer that covers a surface of the insulated conductive wire 368. Accordingly, in the grooves 358 and the slots 322, the insulated conductive wire 368 is electrically insulated from the stator section 320 by the wire insulator 372 and the insulator 370.

The insulated conductive wire 368 can be formed around the stator core 350 using methods known in the art into the desired stator-winding configuration to form the stator coil 324. For example, the wires may be shaped to form a complete poly-phase stator winding, or may be shaped to form separate single-phase stator windings, which subsequently may be combined into a multiple phase configuration, if the desired application so requires. In various embodiments, the stator coils 324 can be produced from conductive wire of a desired gauge, the conductive wire comprising a single strand conductive wire pre-coated with insulation. For example, in some embodiments, Phelps Dodge Industries brand AWG #15 wire or equivalent may be used. In other embodiments, the wire gauge typically will be AWG-18. Other gauge wires are also possible.

In various embodiments, the insulated conductive wires 368 are wound longitudinally around the stator section 320 in the slots 322 to form winding turns 374 contained completely within each groove 358. That is, each insulated conductive wire 368 includes a predetermined length such that when the wire 368 is wound around the stator section 320 to form the stator coil 324, the winding turns 374 are contained within the groove 358. In other words, the winding turns 374 do not extend above the first end 360 or the second end 362 of the of the stator core 350. Containing the winding turns 374 within each groove 358 of the stator section 320 can protect the winding turns 374 from exposure to other parts of the stator section 320, and/or from damage by moving parts during the manufacturing process. In addition, by containing the winding turns 374 within the grooves 358 of the stator section 320, less insulated conductive wire 368 can be used in the manufacture of the stator section 320. This reduces the amount of heat that the wires can produce, in addition to reducing the costs and weight of the finished stator.

In various embodiments, the stator section 320 includes terminal portions 376 of the insulated conductive wires 368 In the embodiment illustrated in FIGS. 3A-3C, six insulated conductive wires (e.g., six wires in hand) are used for each stator section 320 and thus each stator section 320 will include two terminal portions 376, where each terminal portion has six wires. As one of ordinary skill will appreciate, the number of insulated conductive wires 368 used for each stator section can vary and can depend on the desired application for which the stator section 320 is to be used.

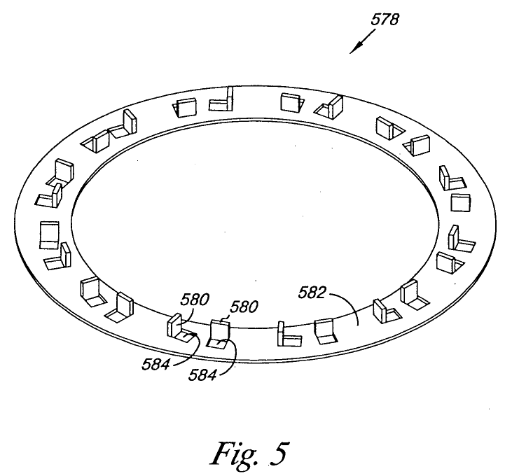

In various embodiments, the terminal portions 376 can extend above a first and/or second end 360 and 362 of the stator core 350. In the embodiment illustrated in FIGS. 3A-3C, the terminal portions 376 extend a predetermined distance above the first end 360 of the stator core 350. In various embodiments, a lead frame can be provided such that the terminal portions 376 pass through an opening in the lead frame and are conductively coupled to tabs on the lead frame at a termination point, as will be discussed below with respect to FIG. 5.

FIGS. 4A-4C illustrates another embodiment of the stator section 420 of the present invention. FIG. 4A illustrates a top down view of the stator section 420. FIG. 4B illustrates a side view of the stator section 420 and FIG. 4C illustrates a cross-sectional view of the stator section 420 as indicated by cut line 4C-4c. The stator section 420 illustrated in FIGS. 4A-4C includes many of the same features as those described and illustrated in FIGS. 3A-3C. For example, the stator section 420 includes the stator core 450 formed of stacked laminations of metal. Thus, only those features that differ from features of the stator section illustrated in FIGS. 3A-3C will be described.

The stator core 450 illustrated in FIGS. 4A-4C includes the outer portion 452, the middle portion 454 and the inner portion 456, which resembles a T-shape when viewed in the axial direction (top down view of FIG. 4A). The middle portion 454 of the stator core 450 further includes slots 422 extending longitudinally along the middle portion 454 of the stator core 450 and between the first end 460 and the second end 462 of the stator core 450. Similar to the slots 322 illustrated in FIGS. 3A-3C, the slots 422 include a predetermined depth relative to edges 466 of the inner portion 456 of the stator section 420.

The first and second ends 460 and 462 of the stator core 450 further include planar surfaces (i.e., the inner portion 454, the middle portion 456, and the outer portion 458 of the stator section at the first and second ends have planar surfaces that do not include grooves as discussed herein). As such, the stator coil 424 includes winding turns 474 that extend away from the first end 460 and the second end 462 (i.e., extend above the first end 460 and below the second end 462) of the stator core 450 by a predetermine distance above the first and second ends 460 and 462.

The stator section 420 also includes terminal portions 476 extending a predetermined distance above the stacked winding turns 474 of the stator coil 424 at the first end 460. In various embodiments, a lead frame can be provided such that the terminal portions 476 pass through an opening in the lead frame and are conductively coupled to tabs on the lead frame at termination points, as will be discussed below with respect to FIG. 5.

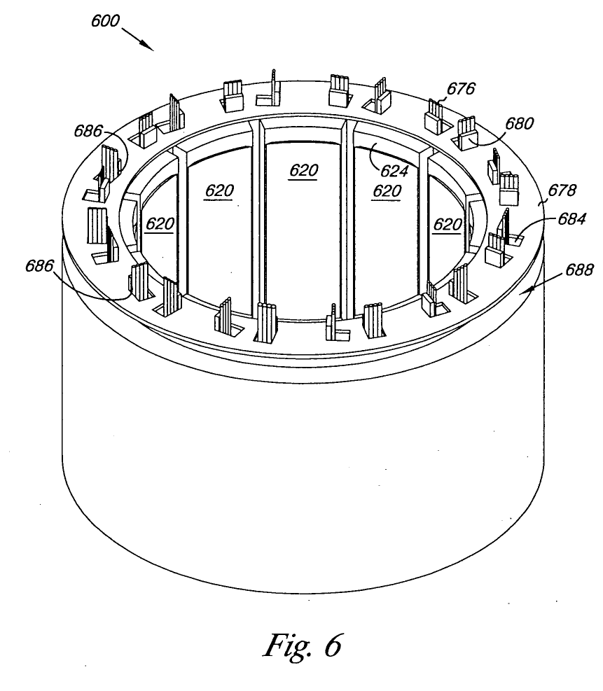

FIG. 5 illustrates an embodiment of a lead frame 578. In various embodiments, the lead frame 578 can be used to electrically couple terminal portions of the insulated conductive wires, as discussed herein. As shown in FIG. 5, the lead frame 578 includes a cylindrical configuration with a number of tabs 580 extending above a surface 582 of the lead frame 578. In addition, the surface 582 defines an opening 584 through the lead frame 578. As illustrated, the tabs 580 are positioned adjacent the opening 584. The tabs 580 are also offset relative to each other to accommodate terminal portions of insulated conductive wires wound in a particular stator coil configuration. An embodiment of this aspect of the invention is illustrated in FIG. 6.

In various embodiments, terminal portions of the insulated conductive wires can extend through the opening 584 and be coupled to the tab 580 at a termination point to form an electrical connection between stator coils and a power source. In various embodiments, the terminal portions of the insulated conductive wires can be mechanically or chemically coupled to the tabs at the termination points. Examples include the use of an automatic welding process, a manual welding process, a soldering process, fasteners, and/or adhesives.

In various embodiments, the lead frame 578 can be positioned such that the lead frame 578 is adjacent the first end or the second end of each stator section. In such embodiments, a gap, or space, can exist between the lead frame 578 and the first or the second end of each stator section. As will be discussed herein, the thermoset material that encases the stator fills the gap between the lead frame 578 and the end of the stator sections.

The lead frame 578 can include electrical paths and connections for various switches, capacitors, and the like. The lead frame 578 also includes electrical paths for the terminal portions of each insulated conductive wire of each stator section. In addition, the lead frame 578 can include one or more electrical connections that extend from the lead frame 578 for coupling to a power source and other components of the motor. As will be appreciated, electrical paths and terminations on the lead frame 578 can be designed to provide proper electrical connections of the terminal portions of the insulated conductive wire for a specific motor phase (e.g., single phase, and poly phase electrical motor).

FIG. 6 provides an illustration of the stator 600 in relation to the lead frame 678. As illustrated, the lead frame 678 can be positioned relative the stator 600 where the terminal portions 676 of the stator coils extend through the openings 684 of the lead frame 678. In addition to extending through the lead frame 678, the terminal portions 676 of the stator coils are also coupled to the tabs 680 of the lead frame 678 at the termination points.

As illustrated, the tabs 680 and the terminal portions 676 can be configured so that at least a portion of each wire of the terminal portions 676 are directly coupled to tab 680 of the lead frame 678 at the termination point. In one embodiment, the terminal portions 676 for each stator section 620 can be distinguished from each other based on the relative position of a contact surface 686 of the tab 680 to which they are attached. For example, as illustrated in FIG. 6 every other contact surface 686 of the tab 680 on the lead frame 678 has the same relative position, while adjacent contact surfaces 686 of the tabs 680 have a different relative position (e.g., each adjacent contact surface 686 is perpendicular to each other and orthogonal to the lead frame 678).

The stator illustrated in FIG. 6 can include stator sections as illustrated in either FIGS. 3A-3C and/or FIGS. 4A-4C. When stator sections as illustrated in FIGS. 3A-3C are used, the lead frame 678 can be positioned adjacent the first surface of each stator section 620 so as to be above the stator coils 624 of each stator section 620. Alternatively, when stator sections as illustrated in FIGS. 4A-4C are used, the lead frame 678 can be positioned adjacent the winding turns of each stator section 620 so as to be above the stator coils 624 of each stator section 620. In one embodiment, positioning the lead frame 678 adjacent the first surface of each stator section 620 can help to reduce the overall size of the stator 600, which in turn, can reduce the amount of material and thus, the weight and cost associated with manufacturing the stator (e.g., insulated conductive wire and thermoset material).

Regardless of the configuration of the stator section used with the lead frame 678, gaps 688 between the lead frame 678 and the stator sections 620 are filled with the thermoset material, as discussed herein. As will be discussed below with respect to FIGS. 7A-7B, the gap 688 can be filled with a thermoset material in a molding process.

Methods and processes for forming the stator and various components of the stator described herein are provided as non-limiting examples of the present invention. As will be appreciated, a variety of molding processes exist that can be used to form the over molding component of the stator. Examples of such molding processes can include resin transfer molding, compression molding, transfer molding, and injection molding, among others. A useful molding process can also be found in co-pending U.S. application Ser. No. ______ entitled ______ assigned Delaware Capital Formation and filed on ______ which is incorporated by reference in its entirety.

FIGS. 7A and 7B illustrate embodiments of a molding tool that can be used in a molding process to form embodiments of the stator of the present invention. The process for molding the stator can include supplying a thermoset material to the molding tool such that when the thermoset material is cured, it completely encapsulates the stator.

The following description provides an example of a process for forming an over molded stator according to the teachings described herein. In the following description, some structural features (e.g., recesses) are described, but not shown in the embodiments of FIGS. 7A and 7B. Thus, where structural features are described, but not shown, the description will refer to the embodiment illustrated in FIG. 1A.

As will be appreciated, the stator can be placed within a molding tool and the thermoset material can be supplied to the molding tool to encapsulate the stator. In one embodiment, the thermoset material can be supplied to the molding tool to completely encapsulate the stator. In some embodiments, the stator can first be encapsulated within the thermoset material and then receive the stator housing. In other embodiments, the stator can be positioned within the stator housing prior to being encapsulated with the thermoset material.

FIG. 7A illustrates a molding tool 790 that includes two mold halves 792 each half including a circumferential wall 794 and a cylindrical cover 796 axially coupled to the circumferential wall 794. Each cylindrical cover 796 includes path extensions 798 annularly arranged along a surface of the cylindrical cover 796 and extending perpendicularly from the surface of the cylindrical cover 796 a predetermined distance. The path extensions 798 define and provide for the channels 732 for circulating cooling fluid in an over molded stator, as discussed above with respect to FIG. 2. As shown in FIG. 7A, path extensions 798 include lengths that when combined, equal the length of the channels 732. As the reader will appreciate however, in various embodiments, the path extensions 798 can be included on just one molding half 792. In such embodiments, the length of the path extensions 798 will equal the length of the channels 732.

The molding tool 790 also includes a mold port 701 extending through a wall of one of the cylindrical covers 796. The molding port 701 provides the proper connections for supplying the thermoset material to the interior of the molding tool 790 in the molding process. The molding tool 790 also includes electrical connector ports 703. As shown in FIG. 7A, the electrical connector ports 703 extend through the circumferential wall 794 and are sealably designed to receive electrical connectors 710, which extend through the electrical connector ports 703.

In various embodiments, the electrical connector ports 703 can be positioned at other locations on the molding tool 790 (e.g., the cylindrical covers 796). The electrical connector ports 703 are sealably designed to receive the electrical connectors 710, which pass through the electrical connector ports 703 to extend to the exterior of the molding tool 790. The electrical connector ports 703 form a fluid and pressure tight seal to prevent the thermoset material from discharging from the molding tool 790 through the electrical connector ports 703 during the molding process.

Also shown in FIG. 7A is a stator 700 formed according to the teachings described herein. The stator 700 is encapsulated within the thermoset material 708 and includes channels 732 positioned between stator sections 720. For reasons of simplicity, the stator 700 in FIG. 7A illustrates only two stator sections 720. However, as will be appreciated, an over molded stator will include a number of annularly arranged stator sections such that a contiguous cylindrical stator is formed. In order to over mold the stator 700 shown in FIG. 7A, the stator 700 is registered within the molding tool 790. Registering the stator within the molding tool 790 includes aligning recesses 728 located on each stator section 720 of the stator 700 with inwardly facing molding protrusions 705 located on an inner surface of the circumferential wall 794 of the molding tool 790 and fixing the protrusions 705 within the recesses 728.

As will be appreciated, the molding tool 790 can be designed to include registers for a central pillar (shown as 707 in FIG. 7B). The central pillar 707 includes a cylindrical shape having outer surfaces 709 that help to define the inner surfaces 714 of the stator 700 when the thermoset material is supplied to the molding tool 790. After the central pillar 707 has been registered within the molding tool 790, the molding tool 790 is closed to form a fluid and pressure tight seal and a thermoset material can then be provided.

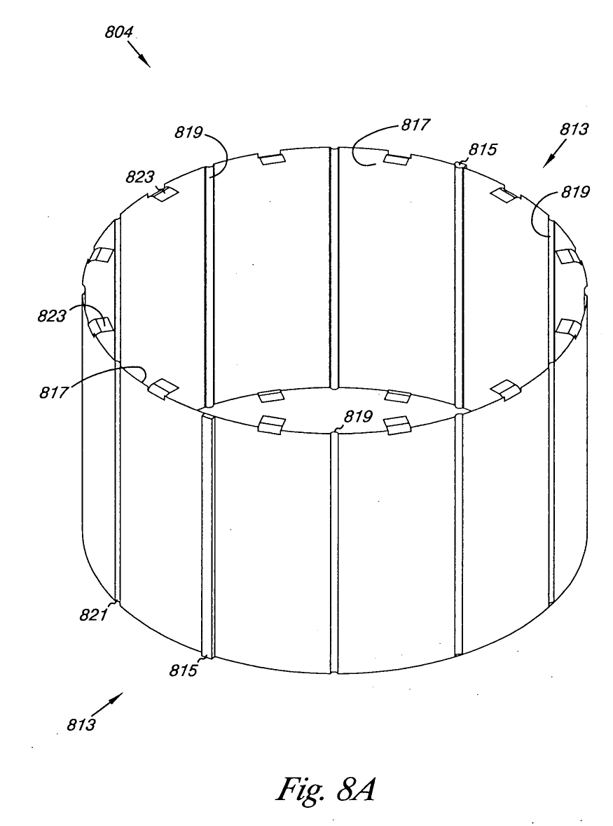

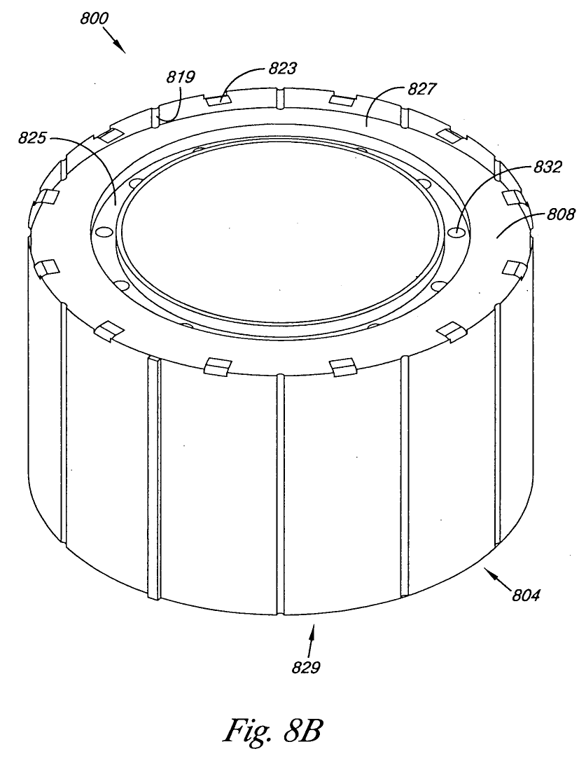

Providing the thermoset material can include injecting a thermoset precursor (e.g., low-viscosity thermoset precursor) and catalyst (optional) into the molding under low pressure to fill the molding tool 790 such that the thermoset material 708 encapsulates the stator 700 except the electrical connectors 710, which extend therefrom. Since the thermoset precursor can include a low viscosity, the thermoset precursor can substantially fill spaces defined by various surfaces of the stator 700, such as spaces between and around insulated conductive wires, spaces within slots and grooves, and spaces between the inner surface of the circumferential wall 794 and the outer surface 730 of each stator section 720, among other spaces. Heat and pressure can then be applied to cure the thermoset precursor to form the over molded stator 700. A post cure process can also be used. After curing, the molding tool 790 can be removed from the over molded stator 700 and the over molded stator 700 can then be fixed within a stator housing, as will be discussed with respect to FIG. 8.

Encapsulating (e.g., completely encapsulating) the stator within a thermoset material can provide for improved heat transfer characteristics there from. For example, the thermoset material encasing the insulated conductive wires serves to efficiently conduct heat away from the wires and also to fill the gaps between the wires where they extend from the ends of the stator sections. In addition, the various portions of the stator can be tightly secured together by complete encapsulation. For example, the capsule serves to secure the insulated conductive wires to the stator section to prevent movement of the wire. The thermoset material also serves to secure the stator sections to each other to help prevent the movement of the stator sections with respect to each other. Such a feature can reduce the cost of the stator because the stator does not require a stator ring, a common portion of a stator in the prior art used to secure the annular sections to each other. The thermoset material can also serve to secure the stator to the housing, as will be discussed below.

FIGS. 8A illustrates an embodiment of a stator housing 804 for an over molded stator. As shown in FIG. 8A, the stator housing 804 includes two housing members 813 joined by two coupling members 815. As shown in FIG. 8A, the stator housing 804 includes inner surfaces 817 having a number of inwardly facing housing protrusions 819 arranged axially along the inner surface 817 and extending longitudinally between first and second axially facing ends of the stator housing 804. The inwardly facing housing protrusions 819 can serve as both a register for a stator section fitted to the housing protrusion 819 and also to register the stator housing 804 with a molding tool, such as molding tool 790 illustrated in FIGS. 7A and 7B in the case where a stator is fixed within a stator housing prior to being molded, as discussed above. In addition, in some embodiments, the housing protrusions 819 can serve as stator housing recesses 821 for registering the stator housing 804 within a housing of an electric motor, such as the housing 237 illustrated in FIG. 2.

The stator housing 804 also includes a number attachment members 823 arranged circumferentially along first and second ends of each housing member 813. The attachment members 823 are bendable and can be used to secure end caps to the stator housing 804 to seal the stator within the stator housing after it has been over molded.

FIG. 8B illustrates an embodiment of a stator 800 encapsulated within a thermoset material 808 and secured within the stator housing 804. The stator 800 includes a surface that defines a fluid feed 825 extending circumferentially along the stator 800 at a first axial end 827 of the stator 800. A second fluid feed (not shown) is defined by a surface at a second axial end 829, which can be a mirror image of the surface defining the fluid feed 825 at the first axial end 827. As shown in FIG. 8B, the fluid feed includes channels 832 that extend longitudinally between axially facing ends 827 and 829 of the stator.

As discussed above with respect to FIG. 2, the stator 800 can include a heat exchange system. In such embodiments, an inlet chamber can be positioned to enclose the fluid feed 825 at the first axial end 827. Likewise, an outlet chamber can be positioned to enclose the channel (not shown) at the second axial end 829. The inlet and output chambers are in fluid communication with the channels 832 and inlet and outlet ports to provide the closed loop heat exchange system illustrated in FIG. 2.

While the present invention has been shown and described in detail above, it will be clear to the person skilled in the art that changes and modifications may be made without departing from the spirit and scope of the invention. As such, that which is set forth in the foregoing description and accompanying drawings is offered by way of illustration only and not as a limitation. The actual scope of the invention is intended to be defined by the following claims, along with the full range of equivalents to which such claims are entitled.

In addition, one of ordinary skill in the art will appreciate upon reading and understanding this disclosure that other variations for the invention described herein can be included within the scope of the present invention. For example, the piston body and yoke can be used in a piston type compressor.

What is claimed:

1. A stator, comprising:
a stator housing including:
first and second axially facing housing members having an inner surface;
a number of inwardly facing protrusions arranged axially along the inner surface and extending longitudinally between first and second axially facing ends of the first and second housing members; and
a number of coupling members arranged axially along the first and second axially facing ends of the first and second housing members; and
a number of annularly arranged stator sections having at least one recess on an outer surface of each stator section to register with the inwardly facing protrusions.

2. The stator of claim 2, wherein the inwardly facing protrusions of the stator housing serve as recesses for registering the stator housing within a housing of an electric motor.

3. The stator of claim 1, including a lead frame having a cylindrical structure with a number of openings defined by tabs extending radially from a surface of the lead frame.

4. The stator of claim 3, wherein the number of annularly arranged stator sections each include a stator coil having at least one terminal portion extending longitudinally at an end of the stator section and through an opening for coupling to a tab of the lead frame.

5. The stator of claim 3, wherein the lead frame includes a number of electrical connectors coupled to the lead frame, the number of electrical connectors determined by an arrangement of electrical paths, such that the arrangement can provide for one of: a single phase, and a polyphase stator.

6. The stator of claim 1, wherein each stator section includes slots extending longitudinally along a length of the stator section and grooves extending a predetermined distance into the stator section.

7. The stator of claim 6, including insulated conductive wires wound longitudinally around each stator section in the slots to form a stator coil having winding turns contained completely within the grooves.

8. The stator of claim 1, wherein each stator section includes slots extending longitudinally along a length of the stator section.

9. The stator of claim 8, including insulated conductive wires wound longitudinally around each stator section in the slots to form a stator coil having stacked winding turns extending radially from a surface of each stator section.

10. A method, comprising:
providing a molding tool having a circumferential wall and a end cap, wherein the circumferential wall includes an inner surface with an inwardly facing protrusion, and wherein the end cap includes a path extension;
registering a stator section having a recess on an outer surface of the stator section with the inwardly facing protrusion; and
supplying the molding tool with a thermoset material to completely encapsulate the stator section except an electrical connector coupled to the stator section.

11. The method of claim 10, including providing a channel, wherein the fluid the path is defined by the thermoset material.

12. The method of claim 1O, wherein the electrical connector extends from the stator section and through a fluid and pressure tight electrical connector port extending through the circumferential wall.
